(19) United States
(12) Patent Application Publication
(10) Pub. No.: US 2024/0136624 A1
(43) Pub. Date: Apr. 25, 2024

(54) STORAGE BATTERY MODULE

(71) Applicant: COMMEO GMBH, Wallenhorst (DE)

(72) Inventors: Michael SCHNAKENBERG, Wallenhorst (DE); Guido SCHMÜLLING, Wallenhorst (DE); Konstantin SCHALLER, Wallenhorst (DE); Lars HOLLENBRINK, Wallenhorst (DE)

(21) Appl. No.: 18/279,045

(22) PCT Filed: Mar. 3, 2022
(86) PCT No.: PCT/EP2022/055478

§ 371 Date: Aug. 24, 2023

(30) Foreign Application Priority Data
Mar. 5, 2021 (DE) 10 2021 202 163.8

(51) Int. Cl. H01M 50/211; H01M 50/271; H01M 50/30; H01M 50/383; H01M 50/533

(52) U.S. Cl. CPC H01M 50/211; H01M 50/271; H01M 50/394; H01M 50/533; H01M 50/383

(57) ABSTRACT

The invention relates to a storage battery module (10) that includes a housing (12), a plurality of storage battery cells (14) in the housing (12), and a cover layer (20) in the housing (12) and above the storage battery cells (14). Each storage battery cell (14) has at least one weak point (56), and the cover layer (20) includes at least one filter mat section (22) that is gas-permeable over the entire surface and flame-arresting over the entire surface. The filter mat section (22) is situated over the entire surface above all weak points (56) of the storage battery cells (14) contained in the storage battery module (10), or a filter mat section (22) is situated above each weak point (56) of the storage battery cells (14) contained in the storage battery module (10).

### BACKGROUND OF THE INVENTION

### 1. Field of the Invention

The invention relates to a rechargeable storage battery module (or an electrical accumulator module) that includes a plurality of rechargeable storage battery cells (or electrical accumulator cells).

### 2. Description of Related Art

Storage battery modules including a plurality of storage battery cells are known per se, for example from EP 3 472 877 A, EP 3 472 878 A, or EP 3 475 998 A.

It is known that the manner in which energy is stored in a storage battery cell is associated with a slight, but not negligible, risk of fire, or at least the risk of release of hot gases. There is also the risk of thermal runaway of a storage battery cell. For a storage battery module with a plurality of storage battery cells, there is the further risk that a thermal runaway of one storage battery cell affects other neighboring storage battery cells of the storage battery module, resulting in a potentially hazardous chain reaction, or at least in a significant increase in the quantity of very hot gases that escape. This is referred to as propagation from cell to cell.

Storage battery modules that are designed in a special way to reduce a risk of fire are known from WO 2019/121641 A, WO 2020/047846 A, DE 10 2014 012 568 A, DE 10 2018 133 426 A1, EP 2 430 682 B, US 2019/140 233 A, KR 102 072 098 B, DE 10 2019 120 708 A1, DE 20 2014 008 336 U, and US 2017/0 214 103 A, for example. A distinction is made between encapsulated storage battery modules and open storage battery modules. Encapsulated storage battery modules have a gas-tight housing that is closed on all sides, and are provided primarily for use in the automotive field. DE 10 2019 120 708 A1, DE 10 2018 133 426 A1, DE 20 2014 008 336 U, and US 2017/0 214 103 A describe encapsulated storage battery modules. In contrast, open storage battery modules allow a gas to discharge, and are configured for discharge of gas. Examples of open storage battery modules are described in DE 10 2014 012 568 A1 and WO 2019/121641 A1.

In the category-defining WO 2019/121641 A, first and foremost a multilayer thermal insulation element for thermal insulation of a battery is proposed. The multilayer thermal insulation element includes the at least one heat-resistant fiber layer. A group of storage battery cells (referred to there as battery cells) in an upright, vertical orientation are situated next to one another in a housing of the storage battery module (referred to there as a battery). The thermal insulation element is situated between individual storage battery cells or between groups of storage battery cells. A further thermal insulation element is situated over the entire surface above the storage battery cells. An opening is provided in the thermal insulation element, situated above the storage battery cells, for the discharge of gas.

A multilayer thermal insulation element for thermal insulation of a storage battery module is likewise known from WO 2020/047846 A. This multilayer thermal insulation element as well is intended for use in or at a housing of the storage battery module and between individual storage battery cells.

In the storage battery module proposed in DE 10 2014 012 568 A, the storage battery cells (galvanic cells) are in a dimensionally stable enclosure having an interior separating device. The enclosures have openings through which gases, which develop when a galvanic cell fails, may escape after passing through the separating device. The openings impart an outflow direction to the escaping gases. The material of the separating device is intended to adsorb particles that are entrained by the escaping gases. A flashover arrester which is permeable to the escaping gases but which holds back entrained glowing particles or flames is also provided in the flow direction of the escaping gases.

The storage battery module proposed in EP 2 430 682 B (referred to there as a battery unit) includes a stack of flat cells, between which are situated cooling plates having at least one angled edge, the edges of neighboring cooling plates being angled in the same direction and partially overlapping one another, via which gas escaping from a cell is to be deflected toward the side.

The storage battery module proposed in US 2019/140233 A includes a plurality of round cells oriented in parallel to one another, the round cells being enclosed by a thermal insulation material, the thermal insulation material having channels between the round cells for air to flow through, but also for hot gases to escape in the event of damage.

### SUMMARY OF THE INVENTION

Accordingly, the object of the present invention is to provide a storage battery module, including a plurality of storage battery cells, that is improved in this regard.

The object mentioned at the outset is achieved according to the invention by means of a battery, referred to here and in the following discussion as a storage battery module, having the features of Claim 1. The storage battery module (the battery) includes a housing, and in the housing has a plurality of storage battery cells (battery cells). The storage battery cells each have at least one weak point, in a manner basically known per se. The storage battery module also includes a cover layer in the housing, i.e., in the interior of the housing, above the storage battery cells.

The special feature of the storage battery module proposed here, on the one hand, lies in the type of cover layer, which includes the at least one filter mat section which is gas-permeable over the entire surface and flame-arresting over the entire surface, and which is placed in the interior of the housing of the storage battery module, below an upper housing part that allows discharge of gas from the interior of the storage battery module, and on the other hand lies in the position of the or each filter mat section relative to the weak points of the storage battery cells contained in the storage battery module.

The upper housing part, which allows discharge of gas from the interior of the storage battery module, preferably has openings, apertures, boreholes, slots, or the like over large areas, through which gas is discharged from the interior of the storage battery module in the event of damage. The discharge of gas initially takes place through the at least one filter mat section that is gas-permeable over the entire surface and flame-arresting over the entire surface, and then through the openings, apertures, boreholes, slots, or the like in the upper housing part. Unlike the example of a valve or the like, the openings, apertures, boreholes, slots, or the like are permanently open in the sense of allowing discharge of gas.

A weak point of a storage battery cell is, for example, a defined function of the cell housing, i.e., a predetermined breaking point, or a function of an integrated component, for example a valve, or the technically weakest point of a particular outer enclosure (outer casing) of a storage battery cell. In the event of a damage situation, gas, typically very hot gas, escapes from the storage battery cell in the region of a failing weak point.

For storage battery cells in the form of so-called pouch cells, the region of a transition between an enclosure of the storage battery cell and a metal tab that passes through the enclosure and functions as a contact element is a weak point. The particular weak point of a storage battery cell is not necessarily a concrete feature of a storage battery cell, even though the basis for a weak point may be, for example, a notch or the like in the enclosure or a section of the enclosure of the storage battery cell. For numerous storage battery cells that come into consideration for use with the storage battery module proposed here, in particular for so-called pouch cells, the weak point results from a material transition, namely, the transition from the material of the enclosure to the material of the metal tab. In the case of a pressure rise in the interior of the storage battery cell, this region is the technically weakest point of the storage battery cell, so that designating this region as a weak point is justified. Other storage battery cells, for example round cells or prismatic cells, also have material- or design-related weak points.

With regard to such weak points of the storage battery cells contained in the storage battery module, it is provided that the cover layer includes exactly one or at least one filter mat section that is gas-permeable over the entire surface and flame-arresting over the entire surface. For exactly one filter mat section, this filter mat section is situated over the entire surface and uniformly spaced over all or essentially all weak points of the storage battery cells contained in the storage battery module. For multiple filter mat sections, a filter mat section is situated above the weak points of all or essentially all storage battery cells contained in the storage battery module, in particular either exactly one filter mat section above a or each individual weak point or above essentially all weak points, or exactly one filter mat section above one or more groups of weak points, so that a filter mat section is uniformly spaced above all or at least essentially all weak points. Mixed configurations are possible, such that exactly one filter mat section is situated above at least one individual weak point, and/or exactly one filter mat section is situated above at least one group of weak points. When the at least one filter mat section is placed above essentially all weak points, for example above at least 80% of the storage battery cells contained in the storage battery module, storage battery cells situated, for example, in the storage battery module at the edge and their weak points are not covered by the filter mat section or a filter mat section. The filter mat section or a filter mat section is uniformly spaced with respect to the weak points above which it is situated, in that the distances from each weak point to the filter mat section are in each case equal or at least essentially equal, i.e., within the range of position- or location-dependent tolerances.

The cover layer thus includes at least one particular filter mat section that has the stated properties. The filter mat section may be so large that it forms the entire cover layer. Otherwise, the at least one filter mat section is integrated into the cover layer or connected to the cover layer, and extends in the plane of the cover layer. The cover layer may include exactly one filter mat section, for example one strip-shaped filter mat section, or a plurality of individual filter mat sections that are integrated into the cover layer, for example along a line or in the form of a matrix.

The or each filter mat section is placed as close as possible above these weak points, namely, as close as possible above the weak points of all storage battery cells contained in the storage battery module. Thus, for a storage battery module with storage battery cells in the form of pouch cells, the or each filter mat section is placed as close as possible above the regions of the storage battery cells having the particular material transitions described above. Hot gas flowing out from a weak point thus reaches the particular filter mat section(s) situated above the weak point as quickly as possible, namely, via the shortest path, passes through the filter mat section(s), and flows out of the storage battery module.

The relative term “above” is based on the fact that in the event of damage in the region of a weak point, escaping gas is very hot and therefore rises. The rising up takes place in the interior of the storage battery module. At that location, the cover layer with the at least one filter mat section is situated above the storage battery cells and is uniformly spaced apart from its weak points. In the event of damage, rising gas thus passes in the interior of the storage battery module from a storage battery cell, which in relation to the cover layer is situated in a lower region of the storage battery module, to the cover layer, which in relation to the storage battery cells is situated in an upper region of the storage battery module, and thus rises upwardly.

The special feature of the proposed storage battery module is that within the housing and above the storage battery cells, the weak points of all storage battery cells contained in the storage battery module are covered, in each case over the entire surface, by means of the at least one filter mat section. The or each filter mat section functions as a fire protection element, and is gas-permeable over the entire surface as well as flame-arresting over the entire surface. The or each filter mat section thus allows gases, in particular hot gases, that develop in the interior of the storage battery module and that escape from a storage battery cell in the event of damage to pass through. However, despite this gas permeability, the or each filter mat section completely holds back flames that may develop in the interior of the storage battery module, and does not allow them to pass through (flame-arresting; thermal runaway resistance).

The advantage of the proposed storage battery module lies in the guiding of possibly escaping gases (gases escaping from a storage battery cell or from multiple storage battery cells in the event of damage). Due to their temperature, such gases rise in the interior of the storage battery module, and thus reach the cover layer situated above the storage battery cells and the at least one filter mat section present there. Since the cover layer, by means of the at least one filter mat section, covers the weak points of all storage battery cells contained in the storage battery module over the entire surface, rising gases reach the at least one filter mat section, and from there pass from the storage battery module by simple ascension on the quickest path. For exactly one filter mat section, the rising gases reach the region of the filter mat section situated directly above the weak point in question by ascension. For multiple filter mat sections, the rising gases reach the particular filter mat section situated above the weak point in question by ascension.

Due to this ascension and the directly subsequent passage through the particular region of the filter mat section or the particular filter mat section, escaping and possibly very hot gases are effectively prevented from, or at least delayed in, spreading in the interior of the storage battery module, reaching neighboring storage battery cells, and at that location possibly likewise causing a discharge of gas. These neighboring storage battery cells are situated transversely with respect to the flow direction of the rising gases, and the rising gases therefore reach the neighboring storage battery cells to a much lesser extent.

Another advantage of the proposed storage battery module is that the or each filter mat section is gas-permeable over the entire surface. For example, a needled nonwoven, in particular a needled nonwoven based on SiO₂ glass fibers, may be considered as a material. Regardless of the particular storage battery cell of the storage battery module from which gases escape in the event of damage, the gases may flow through the gas-permeable, at least one filter mat section and out of the storage battery module without additionally burdening neighboring storage battery cells or other heat-sensitive components such as cables circuit boards, etc., with thermal energy. Regardless of which storage battery cell releases gases in the event of damage, these gases within the storage battery module always take the shortest path upward, i.e., in the direction of the cover layer, and at the location of ascension pass directly through the cover layer, namely, the particular region of the filter mat section or the particular filter mat section, and thus leave the storage battery module via the shortest path. The discharge of gas from the storage battery module, ensured in this way, guarantees rapid heat dissipation from the storage battery module, and at the same time prevents a pressure rise in the interior of the storage battery module. An explosion hazard which otherwise must be attended to is thus significantly reduced.

A further advantage of the proposed storage battery module is that the or each filter mat section, in addition to the gas permeability over the entire surface, is also flame-arresting over the entire surface. In the event of possible ignition of gases that are released in the interior of the storage battery module, in any case flames do not reach the outside. The fire protection thus ensured generally prevents hazards for persons and property in the region of the storage battery module, in that in the event of damage, escaping gases in the storage battery module rise up (and are able to rise up) via the shortest path to the cover layer, where they pass through the at least one filter mat section and escape from the storage battery module. The passing through of other storage battery cells of the same storage battery module is thus prevented or at least delayed. This fire protection for an individual storage battery module also prevents (or at least delays) a thermal runaway of individual or multiple storage battery cells of one or more further storage battery modules possibly situated nearby, and thus prevents or delays a potentially hazardous chain reaction. Of course, the flame-arresting property of the at least one filter mat section over the entire surface also is associated with the or each filter mat section being nonflammable or at least flame-retardant. For example, a needled nonwoven, in particular a needled nonwoven based on SiO₂ glass fibers, for example a needled nonwoven made of drawn amorphous silicate fibers with an SiO₂ fraction of greater than 94% and a 1-3% fraction of aluminum oxide, may be considered as a nonflammable or at least flame-retardant material.

In comparison to WO 2019/121641 A or WO 2020/047 846 A, in the storage battery module proposed here the at least one filter mat section of the cover layer functions not as a thermal insulation element that is intended for thermal insulation, but, rather, as a passthrough element, namely, as a passthrough element for gases that may develop in the event of damage, in particular heat dissipation of the storage battery module also taking place when such possibly very hot gases flow through the at least one filter mat section and out of the storage battery module. In addition, for a comparison based on the present invention, it is noted that in WO 2019/121641 A, at best a minimal discharge of gas on one side of the module is provided, and this individual discharge of gas, depending on the storage battery cell in question, results in a possibly very long path between the site of gas development in the interior of the storage battery module and the site of the possible discharge of gas. Along this path, very hot gas escaping in the event of damage also flows along further storage battery cells, possibly resulting in passage through further storage battery cells, and in the worst case, an overall chain reaction in contiguous storage battery cells. With regard to WO 2020/047846 A, for a comparison likewise based on the present invention, it is noted that a closed system is present in the cited document, ideally with outlets for cables, without mentioning or even taking into consideration gases that develop in the event of damage and a resulting path of the escaping gas.

In comparison to DE 10 2014 012 568 A, for the storage battery module proposed here, exactly one cover layer is provided with a flat or at least essentially flat extension that extends above all storage battery cells contained in the storage battery module, and that includes at least one filter mat section having the properties described above.

In comparison to EP 2 430 682 B, for the storage battery module proposed here, flames possibly developing in the interior of the storage battery module in the event of damage are not kept away by, for example, bypassing other storage battery cells contained in the storage battery module. Instead, the proposed concept ensures an option for hot gases to rise up and reach the cover layer with the at least one filter mat section situated there, having the above-described properties, via the shortest path. Due to the flame-arresting property of the or each filter mat section, flames are prevented from escaping from the storage battery module.

In comparison to US 2019/140233 A, for the storage battery module proposed here, in particular a cover layer that covers/overlays all storage battery cells is provided. This difference from the prior art allows the particularly apt statement that the coverage of the storage battery cells by means of the cover layer and the at least one filter mat section situated there, provided for the storage battery module proposed here, may also be referred as an overlay of the storage battery cells. Thus, the coverage of the storage battery cells brought about by means of the cover layer expressly means no direct contact with the storage battery cells.

Advantageous embodiments of the proposed storage battery module are the subject matter of the subclaims. Back-references that are used within the claims refer to the further development of the subject matter of the referenced claim by the features of the respective dependent claim. They are not to be construed as a waiver of the attainment of independent subject matter protection for the features or feature combinations of a dependent claim. Furthermore, with regard to an interpretation of the claims and of the description, in the event of a more precise specification of a feature in a dependent claim, it is to be assumed that there is no such limitation in the respective preceding claims or in a more general embodiment of the storage battery module according to the invention. Accordingly, any reference in the description to aspects of dependent claims is expressly to be construed as a description of optional features, without particular mention.

In one advantageous embodiment of the storage battery module, this storage battery module includes storage battery cells in the form of so-called pouch cells. These pouch cells have their weak point in the region of a transition between an enclosure of the storage battery cell and a metal tab that passes through the enclosure and functions as a contact element. For exactly one filter mat section of the cover layer, this filter mat section is placed in the immediate vicinity of the weak points of all storage battery cells contained in the storage battery module (pouch cells). For multiple filter mat sections, they are placed in the immediate vicinity of each weak point of all storage battery cells (pouch cells) contained in the storage battery module (exactly one filter mat section above each weak point in each case, and/or exactly one filter mat section above groups of weak points in each case). In this way, the above-described advantages are also ensured for a storage battery module that is fitted with pouch cells.

The storage battery module preferably contains the storage battery cells, in particular in the form of so-called pouch cells, in the housing in a vertical orientation and in layers next to one another. The metal tabs of all storage battery cells, which function as contact elements (poles), point upwardly in the interior of the storage battery module, and are all situated in a region in the interior of the storage battery module which for differentiation is referred to as a contact area, since the metal tabs situated in this region are also contacted in this region. In one advantageous but likewise optional embodiment of the storage battery module, this contact area is subdivided by partition walls, and the partition walls and the contact area as a whole are covered over the entire surface by means of the cover layer and the least one filter mat section included by same.

As a result of this vertical orientation of the storage battery cells and the placement in layers next to one another, the storage battery cells themselves and their enclosure form channels that are vertically oriented, i.e., pointing in the direction of the at least one filter mat section, for guiding gas in the interior of the storage battery module. The partition walls adjoining thereabove continue this guiding. Two neighboring partition walls in each case form in the contact area a chimney-like channel in the direction of the cover layer, situated directly thereabove, and the at least one filter mat section at that location. In addition, the partition walls in the contact area prevent horizontal spreading of rising gases.

In a further advantageous embodiment of the storage battery module, the storage battery cells are combined in pairs to form cell packets, and all cell packets contained in the storage battery module are pressed between two cover plates that are part of the storage battery module. In each case an intermediate layer is situated between two successive cell packets, namely, two cell packets directly following one another along the pressed-together cell packets. Each partition wall, i.e., the wall elements that divide the contact area into segments, is/are aligned (or at least essentially aligned) with an intermediate layer in each case between the cell packets. In the contact area, the exact number of partition walls may be provided that corresponds to the number of intermediate walls situated between the cell packets. In that case, exactly one partition wall in each case is aligned with each intermediate layer. The number of partition walls may also be less than the number of intermediate walls. In that case, the partition walls are still aligned with an intermediate layer in each case, but for individual intermediate layers, a partition wall that is aligned with the intermediate layer is dispensed with.

In one particular advantageous embodiment of this storage battery module, having partition walls that are aligned with an intermediate layer in each case, the partition walls are uniformly spaced apart along the cell packets that are pressed between the cover plates.

In a further advantageous embodiment of the storage battery module proposed here, the metal tabs of the storage battery cells (pouch cells) are contactable by means of comb-like contact elements, in which the comb-like structure results from the fact that the contact elements have a plurality of contact fingers, and in an operationally ready storage battery module are contacted by means of these contact elements. The contact elements engage laterally with the contact area. Only the contact fingers are then situated at that location, and a portion of the contact elements that connects the contact fingers is situated at the outermost edge of the contact area, or completely or at least partially outside the contact area. This leaves the contact area free, as much as possible, for gases rising up in the event of damage. Furthermore, rising gases may thus reach the cover layer and the at least one filter mat section situated there via the most direct path possible. The contact area which remains free, as much as possible, for rising gases also ensures that undesirable formation of turbulence in the rising gases is largely eliminated. In the case of partition walls that are segmented by the contact area, the partition walls prevent horizontal spreading of the rising gases, even if turbulence in the rising gases ultimately unavoidably forms.

In yet a further advantageous embodiment of the storage battery module proposed here, the storage battery module has a functional space for heat-sensitive electronic components, circuit boards, lines, and the like. The functional space is partitioned off from the contact area, in which gases that develop in the event of damage rise up to the cover layer and to the at least one filter mat section situated there. The partitioning is preferably provided by means of a cover plate that delimits the storage battery module core on one side.

The claims filed with the present patent application are proposed formulations without prejudice to the attainment of further patent protection. Since in particular the features of the dependent claims, with regard to the prior art on the date of priority, may form separate, independent inventions, the applicant reserves the right to make these or even further feature combinations, heretofore disclosed only in the description and/or drawings, the subject matter of independent claims or declarations of division. Moreover, the features of the dependent claims may also include separate inventions that are independent from the subject matter of the respective referenced claims.

One exemplary embodiment of the invention is explained in greater detail below with reference to the drawings. Corresponding subject matter or elements is/are provided with the same reference numerals in all figures.

The or each exemplary embodiment is not to be construed as limiting to the invention. Rather, within the scope of the present disclosure, supplements and modifications are also possible, in particular those that are apparent to those skilled in the art with regard to achieving the object of the invention, for example by combining or modifying individual features or method steps that are described in connection with the general or specific description section and contained in the claims and/or the drawings, and that by use of combinable features within the scope of the claims result in new subject matter or new method steps or method step sequences.

### BRIEF DESCRIPTION OF THE DRAWINGS

In the figures:

FIG. 1 shows a storage battery module,

FIG. 2 shows the storage battery module according to FIG. 1, with important components in an exploded illustration,

FIG. 3 shows a storage battery module core, situated in the interior of the storage battery module according to FIG. 1, with cover plates mounted on both sides,

FIG. 4 shows the storage battery module core in a partially exploded illustration,

FIG. 5 shows an individual storage battery cell, namely, a storage battery cell in the form of a pouch cell,

FIG. 6 shows the storage battery module core with the storage battery cells (pouch cells) contained therein, and with contact elements intended for contacting the storage battery cells,

FIGS. 7 and 8 show a storage battery module according to the principle of the storage battery module according to FIGS. 1 through 6, and with storage battery cells in the form of pouch cells,

FIGS. 9 and 10 show a storage battery module according to the principle of the storage battery module according to FIGS. 1 through 6, and with storage battery cells in the form of prismatic cells,

FIG. 11 shows a storage battery module according to the principle of the storage battery module according to FIGS. 1 through 6, and with storage battery cells in the form of round cells, and

FIGS. 12 and 13 respectively show a storage battery cell in the form of a prismatic cell and a storage battery cell in the form of a round cell.

### DETAILED DESCRIPTION OF ILLUSTRATED EMBODIMENTS

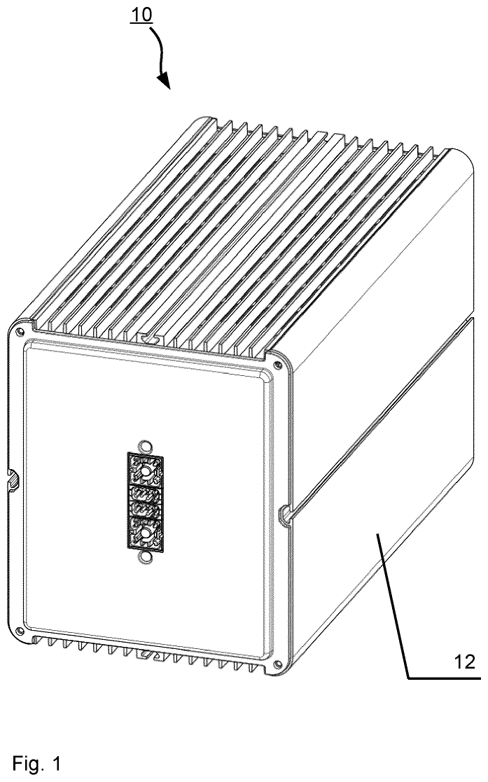

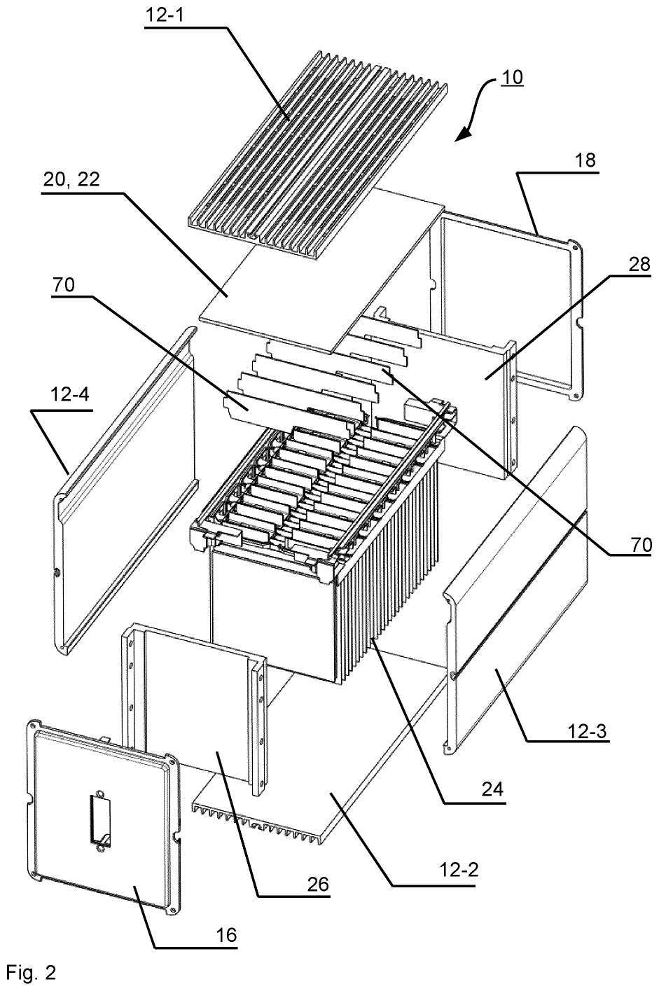

The illustrations in FIGS. 1 and 2 show examples of one embodiment of the storage battery module 10 proposed here. The illustration in FIG. 1 shows the storage battery module 10 in an isometric view and with a closed housing 12. The illustration in FIG. 2 shows the storage battery module 10 from FIG. 1 and important components contained therein in an exploded illustration.

The housing 12 of the storage battery module 10 has multiple housing parts 12-1, 12-2, 12-3, 12-4, namely, at least an upper housing part 12-1, a lower housing part 12-2, and two side housing parts/side walls 12-3, 12-4. At least in the upper housing part and the lower housing part 12-1, 12-2, the housing 12 has cooling ribs over large areas, in particular cooling ribs on the entire outer surface of the upper housing part and/or lower housing part 12-1, 12-2. At least in the upper housing part 12-1—in particular between the cooling ribs—openings, apertures, boreholes, slots, or the like are present over large areas, so that the upper housing part 12-1 is permeable over large areas to gases possibly flowing out from the interior of the storage battery module 10. The upper housing part 12-1, due to an appropriate number, distribution, and/or size of the openings, apertures, boreholes, slots, or the like, is permanently permeable over large areas to gases from the interior of the storage battery module 10, and due to the number, distribution, and/or size of the openings, apertures, boreholes, slots, or the like thus permanently allows, over large areas, discharge of gas from the interior of the storage battery module 10. The storage battery module 10 shown is thus an open storage battery module 10 in the sense of the distinction mentioned at the outset.

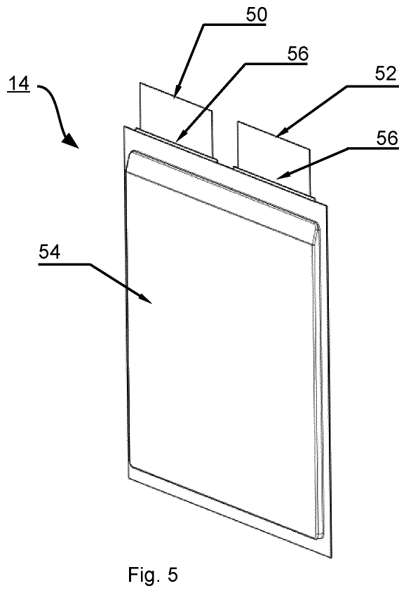

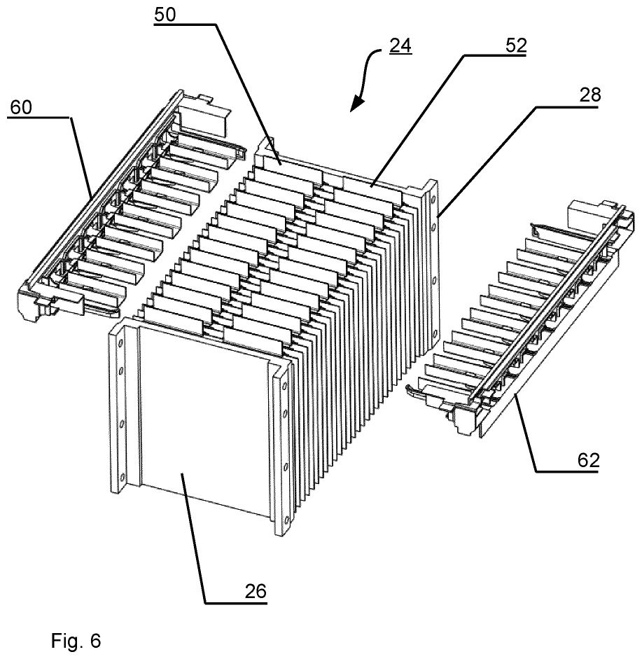

The storage battery module 10 has a plurality of storage battery cells 14 (FIG. 5) in the interior of the housing 12. The housing 12 is closeable on a front-side end and a rear-side end by means of a cover 16, 18, respectively, and in the operationally ready state is closed by means of these covers 16, 18. The cover 16 of the front-side end has openings for contact elements for electroconductively contacting the storage battery module 10. The front-side end is correspondingly also referred to as the connector side. The rear-side end is referred to as the visible side.

Situated in the interior of the housing 12 and below the upper housing part 12-1 is a cover layer 20, in the embodiment shown, a cover layer 20 in the form of a filter mat section 22 (in the embodiment shown in FIG. 2, the cover layer 20 and the filter mat section 22 are thus the same). The exactly one filter mat section 22 is situated over the entire surface above all storage battery cells 14 contained in the storage battery module 10, and thus also above all weak points 56 contained in the storage battery cells 14 (see FIG. 5); the filter mat section 22 covers the storage battery cells 14 contained in the storage battery module 10 and their weak points 56 over the entire surface (overlays the storage battery cells 14 contained in the storage battery module 10 and their weak points 56 over the entire surface).

The or each filter mat section 22 is gas-permeable over its entire surface. Gases, in particular combustible gases, escaping from the storage battery cells 14 or a storage battery cell 14 in the event of damage pass directly from the site of the gas discharge, i.e., a weak point 56, to the filter mat section 22 or to the particular filter mat section 22, and may pass through it over the entire surface, and are not held back by the filter mat section 22 or the particular filter mat section 22. Such gases subsequently exit the upper housing part 12-1, which is permeable to the gases over large areas. The or each filter mat section 22 is also flame-arresting over the entire surface. The or each filter mat section 22 thus allows gases to pass through, but prevents flames from passing through. Due to the at least one filter mat section 22, flames that possibly develop in the event of damage, namely, flames that develop in the interior of the storage battery module 10, do not escape from the storage battery module 10. However, in the event of damage, gases released in the interior of the storage battery module 10 may escape through the at least one filter mat section 22 and then through the upper housing part 12-1, and the escape of the gases serves to prevent, or at least delay, thermal runaway of further storage battery cells 14 in the interior of the storage battery module 10, and in general provides explosion protection.

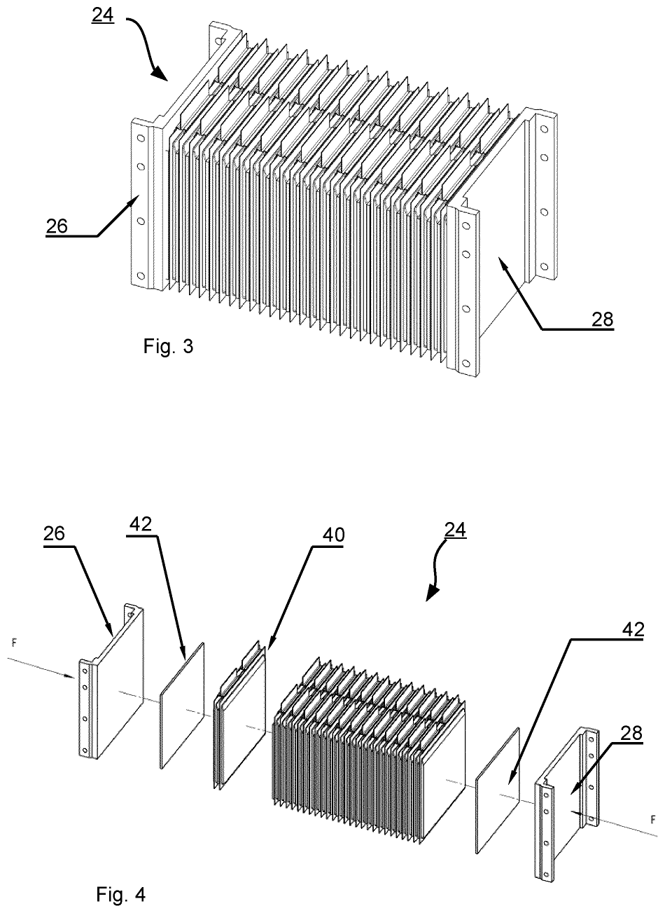

A storage battery module core 24 is situated in the interior of the housing 12 and between its side walls 12-3, 12-4. The storage battery module core 24 is the combination of the storage battery cells 14 contained in the storage battery module 10. The storage battery cells 14 are placed there in a vertical (upright; vertical/upright in the direction of the upper housing part 12-1) orientation in layers next to one another, as is apparent in particular with reference to the illustrations in FIGS. 3 and 4. The storage battery module core 24 is delimited at each of its two end-face sides by a cover plate 26, 28 (front cover plate 26, rear cover plate 28).

The illustrations in FIGS. 3 and 4 show the storage battery module core 24 by itself, i.e., without surrounding housing parts 12-1, 12-2, 12-3, 12-4, and in particular in an isometric view on the one hand (FIG. 3) and in a partially exploded illustration on the other hand (FIG. 4). The illustrations show that the storage battery module core 24 includes a plurality of storage battery cells 14, namely, storage battery cells 14 in the form of so-called pouch cells in each case. The illustration in FIG. 4 shows that in each case two such storage battery cells 14 are combined to form a cell packet 40 (packet of two storage battery cells 14; packet of two pouch cells). In the embodiment shown, the storage battery module core 24 includes a total of fourteen cell packets 40, i.e., twenty-eight storage battery cells 14.

The illustrations in FIGS. 3 and 4 also show that the storage battery module 10, namely, its storage battery module core 24, includes the cell packets 40 and the storage battery cells 14 contained therein in a vertical orientation in each case. The storage battery cells 14 are placed in layers next to one another, resulting in a sequence of storage battery cells 14 (a train of storage battery cells 14; a train of cell packets 40). An intermediate layer 42, in particular an intermediate layer 42 made of a PU foam semi-finished product, is situated in each case between cell packets 40 directly adjoining one another along the train, in a basically optional manner. The train of cell packets 40 with the intermediate layers 42 optionally situated therebetween is closed off on both sides by means of a respective cover plate 26, 28. An intermediate layer 42, which likewise is basically optional, is situated between each cover plate 26, 28 and the cell packet 40 directly adjoining it. The storage battery cells 14 directly adjoining the cover plate 26, 28 or the storage battery cells 14 contained in the cell packets 40 directly adjoining the cover plate 26, 28 are the edge-side storage battery cells 14 in the storage battery module core 24.

The storage battery cells 14 are pressed between the cover plates 26, 28, and in the pressed state the side walls 12-3, 12-4 are connected to the cover plates 26, 28, in particular screwed to the cover plates 26, 28. The fixed length of the side walls 12-3, 12-4 defines the length of the train (measured in the axial direction of the storage battery module 10, along the axis denoted by reference symbol F in FIG. 4) with storage battery cells 14 pressed in the train, and fixes the storage battery module core 24 in the pressed state. The storage battery cells 14 are thus held, overall and relative to one another. The other housing parts, i.e., at least the upper housing part and the lower housing part 12-1, 12-2, are detachably connectable to the or each adjoining housing part in each case, and/or to the storage battery module core 24, for example by screwing.

The storage battery cells 14 contained in the storage battery module core 24 and possibly intermediate layers 42 together have a length, namely, a length that is measured in the axial direction of the storage battery module 10. At least the side walls 12-3, 12-4 have a matching length, namely, a length for which the storage battery cells 14 between the cover plates 26, 28 are accommodated in a press fit; the storage battery cells 14 are pressed between the cover plates 26, 28 by the cover plates 26, 28 (by means of the cover plates 26, 28).

The illustration in FIG. 5 shows an individual storage battery cell 14 in the embodiment as a pouch cell, in an isometric illustration. The storage battery cell 14 (and thus each storage battery cell 14 contained in the storage battery module 10) includes two contacts 50, 52 (positive pole 50, negative pole 52), and each of the two contacts 50, 52 passes from the interior of the storage battery cell 14 and through an enclosure 54 of the storage battery cell 14 to the outside, and rises in a tab-like manner (metal tab 50, 52) above an upper edge of the storage battery cell 14. The region of the passage of the metal tabs 50, 52 through the enclosure 54 of the storage battery cell 14 may be regarded as a weak point 56 of such a storage battery cell 14, namely, a storage battery cell 14 in the form of a pouch cell. Due to the material transition from the material of the enclosure 54, for example an aluminum composite foil, to the material of the metal tabs 50, 52, namely, electrically conductive metal, for example copper or aluminum, the region of this material transition is the technically weakest point of the storage battery cell 14, in particular when an increased amount of gas develops in the storage battery cell 14. A pressure rise due to such increased gas development causes the enclosure 54 in the region of the transition to burst onto the metal tabs 50, 52 or one of the metal tabs 50, 52, and gas, namely, very hot gas in the event of damage, to escape into this region from the interior of the storage battery cell 14.

The illustration in FIG. 6 shows the storage battery module core 24 as shown in FIG. 3 and with the storage battery cells 14, contained therein, pressed between the end-side cover plates 26, 28, but in a different orientation. In addition, two contact elements 60, 62 are shown. These contact elements contact the metal tabs 50, 52 of the storage battery cells 14, i.e., the respective positive and negative poles 50, 52 of the storage battery cells 14. The contact elements 60, 62 include a plurality of contact fingers. The contact elements 60, 62 may also be referred to as comb-like contact elements 60, 62, and the contact fingers may correspondingly be referred to as contact prongs. The contact fingers of each contact element 60, 62 are situated in a plane, and each contact element 60, 62 with its contact fingers laterally engages, in a manner of speaking, with a region that includes the metal tabs 50, 52. The metal tabs 50, 52 are electroconductively contactable in a shared plane by means of the contact fingers of the contact elements 60, 62.

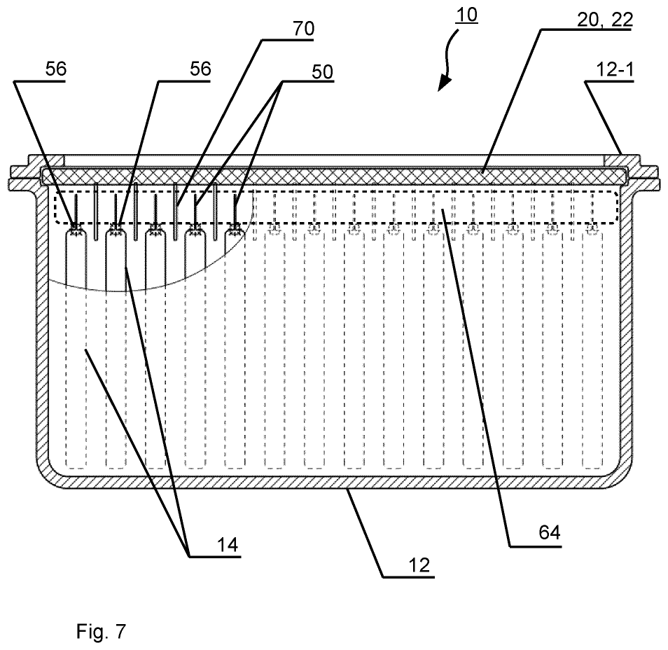

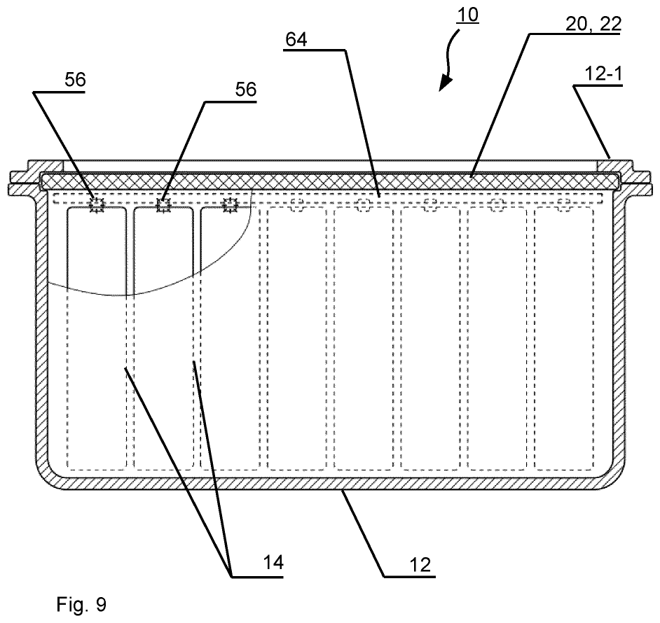

The illustrations in FIGS. 3 and 6 show that the metal tabs 50, 52 of the storage battery cells 14 require space in the interior of the storage battery module 10. The same (space requirements) applies for the contact elements 60, 62 provided for contacting the metal tabs 50, 52. The region including the metal tabs 50, 52 and the contact elements 60, 62 is regarded as a contact area 64 (see FIGS. 7 and 9) in the storage battery module 10. The contact area 64 begins directly above the upper edge of the enclosure 54 of the storage battery cells 14, and extends to directly below the cover layer 20 and the at least one filter mat section 22 at that location. For gases rising up from a storage battery cell 14 or multiple storage battery cells 14 in the event of damage, this is a free or at least essentially free region.

Basically optional partition walls 70 have already been shown in the illustration in FIG. 2. In the center of the illustration, FIG. 2 shows the storage battery module core 24 with the storage battery cells 14 contained therein (not designated in FIG. 2), the metal tabs 50, 52 protruding from the top of the storage battery cells 14 (not designated in FIG. 2), and the contact elements 60, 62 contacting same (likewise not designated in FIG. 2). In a completely assembled storage battery module 10, situated between at least individual metal tabs 50, 52 and the individually designated in FIG. 2). The partition walls 70 are aligned with individual intermediate layers 42 between the cell packets 40. In the embodiment shown, six partition walls 70 are provided, which are aligned with every other intermediate layer 42 of the storage battery module core 24.

A space results in each case between two directly neighboring partition walls 70. These spaces in their entirety are covered by means of the cover layer 20 and/or the at least one filter mat section 22. The at least one filter mat section 22 thus closes off these spaces at the top. In the event of damage, gas escaping from a storage battery cell 14 may rise up into the space situated in each case directly above the storage battery cell 14 in question. Due to the ascension in the interior of the storage battery module 10, and the partition walls 70 which delimit and in a manner of speaking channelize the ascension, the gas, which is possibly very hot or even already ignited, does not reach, or at least essentially does not reach, the region of further storage battery cells 14. Damage to further storage battery cells 14 due to a damage situation for a storage battery cell 14, in particular damage to directly neighboring storage battery cells 14, is avoided in this way, or at least the risk of such damage is greatly reduced or delayed. Due to the two most important properties of the at least one filter mat section 22, namely, gas permeability over the entire surface and flame-arresting over the entire surface, it is ensured that if gases develop in the interior of the storage battery module 10 and ignite in the event of damage, in any case flames do not escape from the storage battery module 10. The rising gas may also flow off through the at least one filter mat section 22 that is gas-permeable over the entire surface.

The further figures (FIGS. 7 through 11) show, in a schematically simplified form, the principle of the storage battery module 10 proposed here in a manner that is reduced to the essential details compared to the preceding figures, and based on different types of storage battery cells 14.

Shown in each case is a storage battery module 10 including a housing 12 and an upper housing part 12-1, a plurality of storage battery cells 14 (only some of which are individually designated) in the housing 12, and a cover layer 20 in the housing 12 and above the storage battery cells 14 and also below the upper housing part 12-1. The housing 12 is gas-tight or at least essentially gas-tight, and only the upper housing part 12-1 has openings, slots, or the like over large areas above the cover layer 20 which allow a large-area discharge of gas from the housing 12. In the sectional illustrations in FIGS. 7 and 9, the section plane is situated in the region of a slot from a plurality of slots in the upper housing part 12-1 (discernible based on the nonhatched region; for a plurality of slots, in particular between and/or below cooling ribs, a grid-like structure results, in any case a structure that is gas-permeable over large areas).

Each storage battery cell 14 has at least one weak point 56 (only some of which are individually designated). The housing 12 encloses the storage battery cells 14 and the cover layer 20 on all sides. The weak points 56 are graphically emphasized in the illustrations by means of a symbol. The symbol in each case is a closed continuous line with multiple dashes uniformly spaced along the continuous line, transverse to the continuous line. These symbols are not concrete features of the storage battery cells 14, and are used solely to illustrate the location or the region of the particular weak point 56.

The cover layer 20 includes at least one filter mat section 22 that is gas-permeable over the entire surface and flame-arresting over the entire surface, it being possible for exactly one filter mat section 22 itself to also be the cover layer 20. When there is exactly one filter mat section 22, it is situated over the entire surface and uniformly spaced above all or at least essentially all weak points 56 of the storage battery cells 14 contained in the storage battery module 10, and when there is more than one filter mat section 22, a filter mat section 22 is uniformly spaced above each or at least essentially each weak point 56 of the storage battery cells 14 contained in the storage battery module 10 (in each case exactly one filter mat section 22 is situated above each or at least essentially each weak point, and/or in each case exactly one filter mat section 22 is situated above groups of weak points).

When the at least one filter mat section 22 just overlays essentially all weak points 56, it may be considered for the weak points 56 of edge-side storage battery cells 14 to not be overlaid. Edge-side storage battery cells 14 are storage battery cells 14 that abut the inner side of a wall surface of the housing 12. For storage battery cells 14 which due to their size always abut an inner side of a wall surface of the housing 12 (for example, pouch cells or prismatic cells), such storage battery cells 14 which with their large surfaces abut an inner side of a wall surface of the housing 12 are edge-side storage battery cells 14.

In particular:

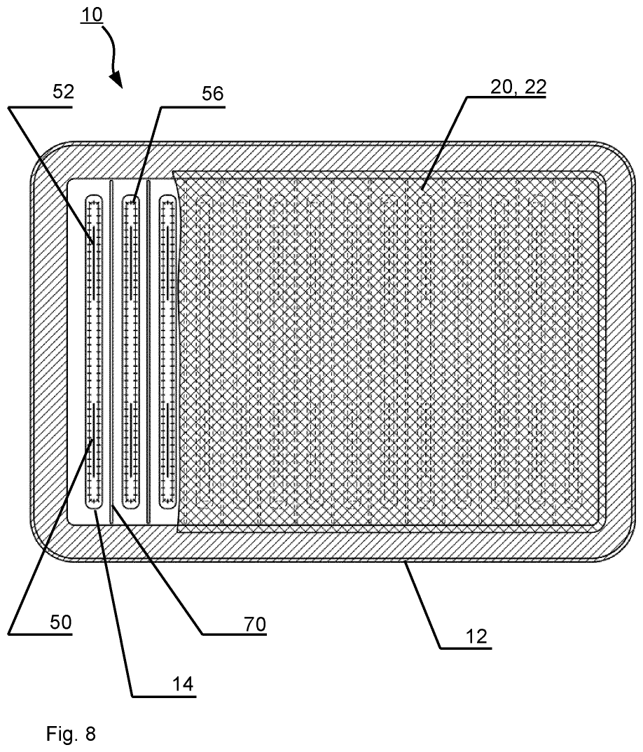

The illustrations in FIGS. 7 and 8 schematically show a simplified view of a storage battery module 10 with storage battery cells 14 in the form of pouch cells, in particular in a side view on the one hand (FIG. 7), and on the other hand in a view from above into the storage battery module 10 (FIG. 8). It is apparent from the view from above in FIG. 8 that an embodiment is shown in which the cover layer 20 includes exactly one filter mat section 22 (in a partially cutaway illustration) that is gas-permeable over the entire surface and flame-arresting over the entire surface. This filter mat section extends up to all lateral housing walls (in the embodiment in FIGS. 1 through 6, the housing side walls 12-3, 12-4 and the front and rear cover plate 26, 28), and is thus itself the cover layer 20. The filter mat section 22 is situated over the entire surface above all weak points 56 of the storage battery cells 14 contained in the storage battery module 10. Alternatively, the filter mat section 22 (at least one filter mat section 22) may be integrated into a cover layer 20, which then functions as a carrier of the or each filter mat section 22, or may be mounted on same. In the side view in FIG. 7, the contact area 64 is depicted above the storage battery cells 14 and below the cover layer 20. In the side view in FIG. 7 and in the top view in FIG. 8, it is apparent that the storage battery module 10 in the interior of the housing 12 has basically optional partition walls 70 (only one of which is designated), and that the filter mat section 22 is situated above all partition walls 70 and in particular rests on their upper edges, and in particular is not in contact with the metal tabs (contacts) 50, 52 of the storage battery cells; this also expressly applies for the embodiment shown in the illustrations in FIGS. 1 through 6. It is apparent in the top view in FIG. 8 that the filter mat section 22 covers all partition walls 70 over the entire surface, and this also expressly applies for the embodiment shown in the illustrations in FIGS. 1 through 6.

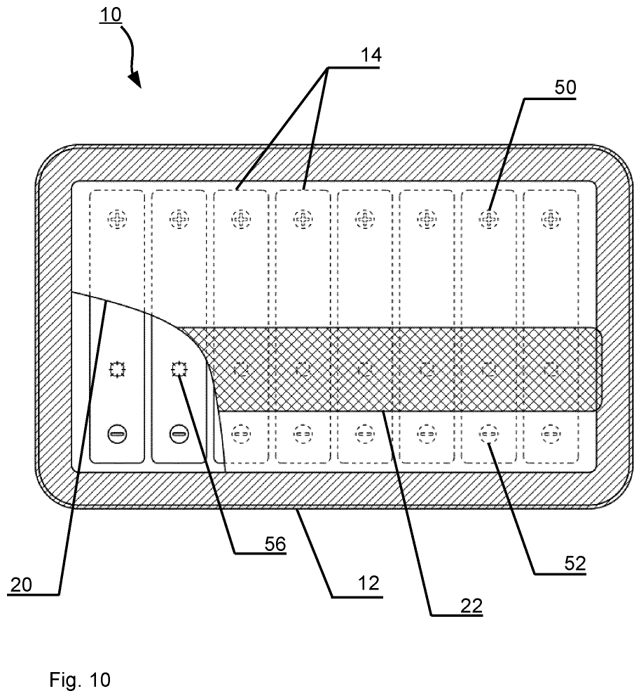

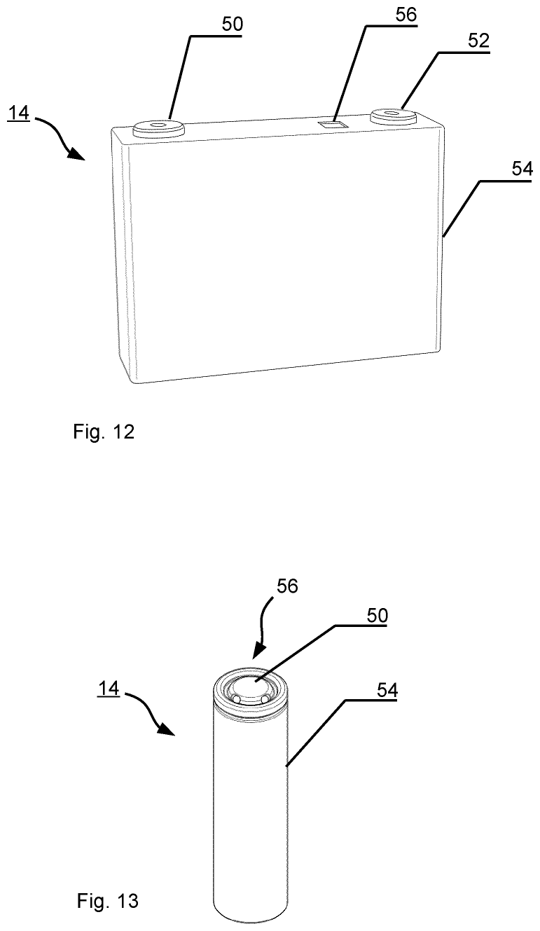

The illustrations in FIGS. 9 and 10 schematically show a simplified view of a storage battery module 10 with storage battery cells 14 in the form of prismatic cells (see FIG. 12), in particular in a side view on the one hand (FIG. 9), and on the other hand in a view from above into the storage battery module 10 (FIG. 10). It is apparent from the view from above in FIG. that an embodiment is shown in which the cover layer 20 (in a partially cutaway illustration) includes exactly one filter mat section 22 (likewise in a partially cutaway illustration) that is gas-permeable over the entire surface and flame-arresting over the entire surface. This filter mat section is situated over the entire surface above all weak points 56 of the storage battery cells 14 contained in the storage battery module 10. The filter mat section 22 is integrated into a cover layer 20 or mounted on the cover layer 20. In combination, the cover layer 20 and the filter mat section 22 extend up to all lateral housing walls. Instead of exactly one filter mat section 22, a plurality of filter mat sections 22 also come into consideration, a filter mat section 22 being situated above each weak point 56 of the storage battery cells 14 contained in the storage battery module 10. In the side view in FIG. 9, the contact area 64 is depicted above the storage battery cells 14 and below the cover layer 20.

The illustrations in FIGS. 7 and 9 illustrate the special aspect of the position of the filter mat section 22 relative to the weak points 56 of the particular overlaid storage battery cells 14 contained in the storage battery module 10. On the one hand, the filter mat section 22 (within the housing 12) is situated above the weak points 56 of the particular overlaid storage battery cells 14. On the other hand, the filter mat section 22 is uniformly spaced above these weak points 56. That is, the distances from each weak point 56 to the filter mat section 22 are equal in each case or at least essentially equal, i.e., within the range of position- or location-dependent tolerances. The distances under consideration are the shortest connection from a weak point 56 to the bottom side of the filter mat section 22. For storage battery cells 14 whose weak points 56, as shown, are situated in a plane, and for a filter mat section 22 that is parallel to this plane, as shown, but in a further plane that is spaced apart from this plane, the weak points 56 are uniformly spaced apart from the filter mat section 22. This uniform distance from all weak points 56 that are overlaid in each case ensures that gases escaping in the region of a weak point 56 in the event of damage rise up in the storage battery module 10 to the filter mat section 22 via the shortest path, and that the path of the gases rising from each weak point 56 in the event of damage to the filter mat section 22 situated thereabove is equal or at least essentially equal. This in turn ensures that rising gases leave the storage battery module 10 via the shortest path (through the upper housing part 12-1, namely, through the upper housing part 12-1 which is permeable over large areas to gases possibly flowing out from the interior of the storage battery module 10 due to openings, apertures, boreholes, slots, or the like), and damage to the storage battery cells 14 not affected by the damage situation is prevented or at least delayed. This is an important difference from the prior art according to KR 102 072 098 B, for example, in which for the storage battery cells situated in parallel horizontal planes, in the event of damage the gas escaping from a lower plane rises up along all storage battery cells situated thereabove, which may thus possibly trigger a thermal runaway for these storage battery cells.

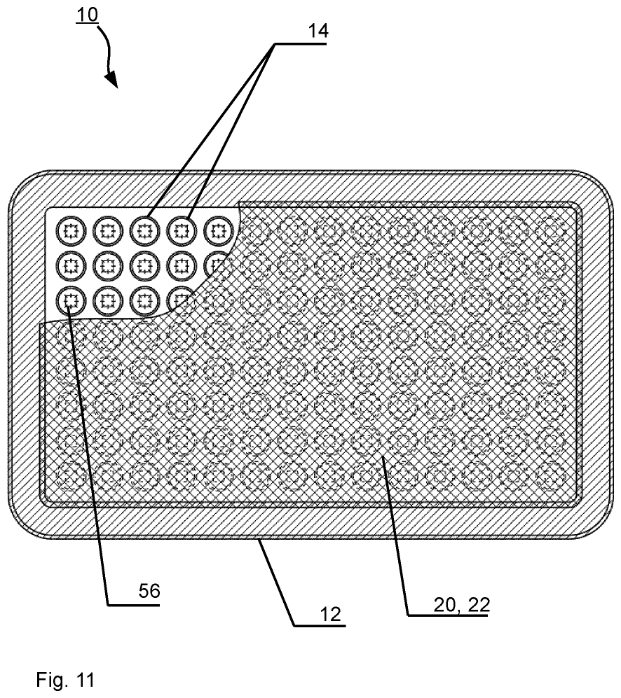

The illustration in FIG. 11 schematically shows (only in a view from above) a simplified view of a storage battery module 10 with storage battery cells 14 in the form of round cells (see FIG. 13). Here as well, an embodiment is shown in which the cover layer 20 includes exactly one filter mat section 22 (in a partially cutaway illustration) that is gas-permeable over the entire surface and flame-arresting over the entire surface. This filter mat section is situated over the entire surface above all weak points 56 of the storage battery cells 14 contained in the storage battery module 10, and extends on all sides up to the lateral housing walls, and also is thus itself the cover layer 20.

The cutaway portion of the filter mat section 22 that functions as the cover layer 20, or of the cover layer 20 and the filter mat section 22, in the illustrations in FIGS. 8, 10, and 11 makes the storage battery cells 14, which otherwise are difficult to recognize, better discernible, and is used only for better understandability of the illustrations.

The illustration in FIG. 12 shows a storage battery cell 14 in the form of a prismatic cell, and the illustration in FIG. 13 shows a storage battery cell 14 in the form of a round cell. The prismatic cell has its weak point 56 between the two poles 50, 52. The round cell has its weak point 56 in the region of the top side, which is the only side visible in the illustration, with the positive pole 50 at that location

Although the invention has been illustrated and described in detail with reference to the exemplary embodiment, the invention is not limited by the disclosed example(s), and other variations may be derived therefrom by those skilled in the art without departing from the scope of protection of the claims.

Individual key aspects of the description filed here may thus be briefly summarized as follows: A storage battery module 10 that includes a housing 12, a plurality of storage battery cells 14 in the housing 12, and a cover layer 20 in the housing 12 and above the storage battery cells 14 is provided. Each storage battery cell 14 has at least one weak point 56, in a manner basically known per se, from which very hot gas escapes in the event of damage. The cover layer 20 above the storage battery cells 14 includes at least one filter mat section 22 that is one gas-permeable over the entire surface and flame-arresting over the entire surface. The filter mat section 22 is situated over the entire surface above all weak points 56 of the storage battery cells 14 contained in the storage battery module 10, or a filter mat section 22 is situated above each weak point 56 of the storage battery cells 14 contained in the storage battery module 10 (exactly one filter mat section 22 above each weak point in each case, and/or exactly one filter mat section 22 above groups of weak points in each case). Gas escaping from a damaged storage battery cell 14 rises up in the storage battery module 10 to the cover layer 20 and to the at least one filter mat section 22 situated there, passes through it, and leaves the storage battery module 10.

### LIST OF REFERENCE NUMERALS

10 storage battery module
12 housing
12-1 housing part, upper housing part
12-2 housing part, lower housing part
12-3 housing part, housing side wall, side wall
12-4 housing part, housing side wall, side wall
14 storage battery cell
16 (front-side) cover
18 (rear-side) cover
20 cover layer
22 filter mat section
24 storage battery module core
26 (front) cover plate
28 (rear) cover plate
30-38 (unassigned)
40 cell packet
42 intermediate layer
44-48 (unassigned)
50 metal tab, contact, positive pole
52 metal tab, contact, negative pole
54 enclosure (of a storage battery cell)
56 weak point (of a storage battery cell)
58 (unassigned)
60, 62 contact element
64 contact area
70 partition wall

1. A storage battery module (10), comprising:
a housing (12) that includes an upper housing part (12-1),
a plurality of storage battery cells (14) in the housing (12), and
a cover layer (20) in the housing (12) and above the storage battery cells (14), wherein:
each storage battery cell (14) having at least one weak point (56),
the cover layer (20) includes at least one filter mat section (22) that is gas-permeable over the entire surface and flame-arresting over the entire surface,
the upper housing part (12-1) has openings, apertures, boreholes, slots, or the like over large areas which allow gas to be discharged from the interior of the storage battery module (10), and
the filter mat section (22) is situated over the entire surface and uniformly spaced above all or essentially all weak points (56) of the storage battery cells (14) contained in the storage battery module (10), or a filter mat section (22) is uniformly spaced above all or essentially all weak points (56).

2. The storage battery module (10) according to claim 1,
wherein each storage battery cell (14) has its weak point (56) in the region of a transition between an enclosure (54) of the storage battery cell (14) and a metal tab (50, 52) that passes through the enclosure (54) and functions as a contact element, and
the filter mat section (22) is placed in the immediate vicinity of all or essentially all weak points (56) of the storage battery cells (14) contained in the storage battery module (10), or a filter mat section (22) is placed in the immediate vicinity of all or essentially all weak points (56).

3. The storage battery module (10) according to claim 2,
a plurality of storage battery cells (14) that are placed with a vertical orientation in the housing (12), in layers next to one another,
the metal tabs (50, 52) of the storage battery cells (14) being situated in a contact area in the interior of the storage battery module (10),
the contact area being subdivided by partition walls (70), and
the partition walls (70) and the contact area as a whole being covered over the entire surface by means of the cover layer (20).

4. The storage battery module (10) according to claim 3,
wherein the storage battery cells (14) are combined in pairs to form cell packets (40), and the cell packets (40) are combined to form a storage battery module core (24),
an intermediate layer (42) is situated in each case between two successive cell packets (40), and
each partition wall (70) is aligned in each case with an intermediate layer (42), or is at least essentially aligned in each case with an intermediate layer (42).

5. The storage battery module (10) according to claim 4,
wherein the partition walls (70) are uniformly spaced apart along the storage battery module core (24).

6. The storage battery module (10) according to claim 3,
wherein the metal tabs (50, 52) of the storage battery cells (14) are contactable by means of comb-like contact elements (60, 62) having a plurality of contact fingers that engage laterally with the contact area.

7. The storage battery module (10) according to claim 3, including a functional space for heat-sensitive electronic components that is partitioned off from the contact area by a cover plate (26) that delimits the storage battery module core (24) on one side.

8. The storage battery module (10) according to claim 1,
wherein the or each filter mat section (22) is a needled nonwoven, in particular a needled nonwoven based on SiO₂ glass fibers.
